(19) United States
(12) Patent Application Publication
(10) Pub. No.: US 2008/0225072 A1
(43) Pub. Date: Sep. 18, 2008

(54) Calibration of drop detector and acquisition of drop detect data for nozzles of fluid-ejection mechanisms

(76) Inventors: Jena Marie Klees, Vancouver, WA (US); Nathan McGoldrick, Vancouver, WA (US); Tod Heiles, Vancouver, WA (US); Michael L. Matthews, Vancouver, WA (US)

Correspondence Address: HEWLETT-PACKARD COMPANY;Intellectual Property Administration, P.O. Box 272400, Fort Collins, CO, 80527-2400, US

(21) Appl. No.: 11/686,903

(22) Filed: Mar. 15, 2007

(51) Int. Cl. B41J 29/393

(52) U.S. Cl. 347/19

(57) ABSTRACT

A drop detector is calibrated to determine a location of a detection zone thereof relative to a carriage and to each of one or more fluid-ejection mechanisms disposed within the carriage. Drop detect data is acquired for nozzles of each mechanism by indexing the carriage in relation to the detection zone and attempting to eject fluid from the nozzles, based on the location of the detection zone relative to the carriage and to each mechanism. It is determined whether the drop detector remains properly calibrated, based on the drop detect data, and repeating the method at calibrating the drop detector where the drop detector is no longer properly calibrated. It is also determined which of the nozzles are properly ejecting fluid therefrom, based on the drop detect data, and attempting to recover the nozzles that are improperly ejecting fluid therefrom.

### BACKGROUND

A common type of fluid-ejection device is an inkjet-printing device, such as an inkjet printer, which ejects ink from nozzles to form images on media. To ensure optimal image quality, such fluid-ejection devices typically verify whether the nozzles are properly ejecting fluid, and if not, perform corrective service actions. To determine whether a given nozzle is properly ejecting fluid, a drop detector is employed to detect whether the nozzle ejects fluid upon being fired. However, if the drop detector is not properly calibrated, it may erroneously indicate that a nozzle is not properly ejecting fluid when the nozzle in fact is.

### BRIEF DESCRIPTION OF THE DRAWINGS

FIG. 1 is a diagram of a representative fluid-ejection device, according to an embodiment of the invention.

FIG. 2 is a diagram of a representative fluid-ejection mechanism, according to an embodiment of the invention.

FIG. 3 is a diagram of a representative die of a fluid-ejection mechanism, according to an embodiment of the invention.

FIGS. 4A and 4B are diagrams depicting how an optical drop detector operates, according to an embodiment of the invention.

FIG. 5 is a flowchart of a method, according to an embodiment of the invention.

FIG. 6 is a diagram of a drop detect profile used in calibrating a drop detector, according to an embodiment of the invention.

FIG. 7 is a flowchart of a method for calibrating a drop detector, according to an embodiment of the invention.

FIG. 8 is a flowchart of a method for acquiring drop detect data for fluid-ejection nozzles of a fluid-ejection mechanism, according to an embodiment of the invention.

FIG. 9 is a flowchart of a method for acquiring drop detect data for fluid-ejection nozzles of a fluid-ejection mechanism, according to an embodiment of the invention.

FIG. 10 is a diagram of a histogram by which whether a drop detector remains properly calibrated can be determined, according to an embodiment of the invention.

FIG. 11 is a flowchart of a method for determining whether a drop detector remains properly calibrated, according to an embodiment of the invention.

FIG. 12 is a flowchart of a method for determining which fluid-ejection nozzles are properly ejecting fluid and on that basis performing nozzle recovery service actions, according to an embodiment of the invention.

FIG. 13 is a block diagram of a rudimentary fluid-ejection device, according to an embodiment of the invention.

### DETAILED DESCRIPTION OF THE DRAWINGS

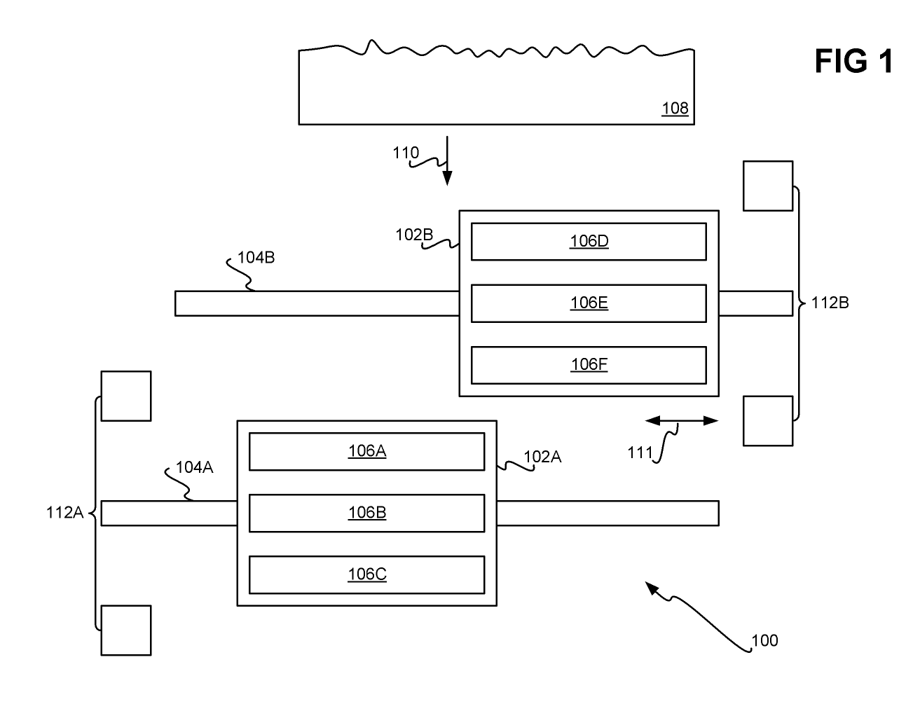

FIG. 1 shows a representative fluid-ejection device 100, according to an embodiment of the invention. It is noted that the fluid-ejection device 100 can include other components, in addition to and/or in lieu of those depicted in FIG. 1. The fluid-ejection device 100 may be an inkjet-printing device, such as an inkjet printer, which forms images on media such as the sheet of media 108 by ejecting ink onto the media.

The fluid-ejection device 100 includes carriages 102A and 102B, collectively referred to as the carriages 102, that are movable on corresponding rods 104A and 104B, collectively referred to as the rods 104, in the directions indicated by the bi-directional arrow 111. The carriage 102A includes fluid-ejection mechanisms 106A, 106B, and 106C, and the carriage 102B includes fluid-ejection mechanisms 106D, 106E, and 106F. The fluid-ejection mechanisms 106A, 106B, 106C, 106D, 106E, and 106F are collectively referred to as the fluid-ejection mechanisms 106.

Where the fluid-ejection device 100 is an inkjet-printing device, the fluid-ejection mechanisms 106 may eject ink or fixer, the latter being a fluid that provides for better adhesion of the ink onto media. The fluid-ejection mechanisms 106A and 106D may eject such fixer. By comparison, the fluid-ejection mechanisms 106B and 106E may eject cyan and magenta ink, whereas the fluid-ejection mechanisms 106C and 106F may eject yellow and black ink. In this embodiment, then, the fluid-ejection mechanisms 106 are inkjet mechanisms.

The carriages 102 remain stationary on the rods 104 while the fluid-ejection mechanisms 106 eject fluid onto media. In particular, the sheet of media 108 moves relative to the carriages 102 as indicated by the arrow 110. As the media 108 moves past each of the fluid-ejection mechanisms 106, fluid is desirably ejected from the fluid-ejection mechanism in question so that, for instance, a desired image is formed on the sheet of media 108.

In this way, the fluid-ejection device 100 is different than other types of fluid-ejection devices, which eject fluid while scanning carriages across sheets of media, advance the media by a swath, and repeat the process. By comparison, the carriages 102 of the fluid-ejection device 100 remain stationary while the media 108 is advanced through the fluid-ejection device 100 for ejection of fluid on the media 108. The fluid-ejection mechanisms 106A, 106B, and 106C of the carriage 102A are sufficiently sized to eject fluid onto the left half of the media 108 without having to be scanned, and the mechanisms 106D, 106E, and 106F of the carriage 102B are sufficiently sized to eject fluid onto the right half of the media 108 without having to be scanned.

To ensure that the fluid-ejection mechanisms 106 of the carriages 102 are properly ejecting fluid, the carriage 102A can be moved along the rod 104A to the drop detector 112A, and the carriage 102B can be moved along the rod 104B to the drop detector 112B. The drop detectors 112A and 112B are collectively referred to as the drop detectors 112. The operation of the drop detectors 112 is described in more detail later in the detailed description. However, in general, the drop detectors 112 detect whether fluid is being properly ejected by detecting the presence of such fluid.

As can be appreciated by those of ordinary skill within the art, the fluid-ejection device 100 as depicted in FIG. 1 is representative, and different variations can be made in different embodiments of the invention. For instance, while two drop detectors 112 are depicted in FIG. 1, in another embodiment, there may be six drop detectors 112. More generally, that is, there may be an equal number of drop detectors 112 and fluid-ejection mechanisms 106. Furthermore, all the drop detectors 112 may be mounted on the same side, as opposed to two different sides, as is depicted in FIG. 1. Other variations may also be made to the general depiction of the fluid-ejection device 100 in FIG. 1.

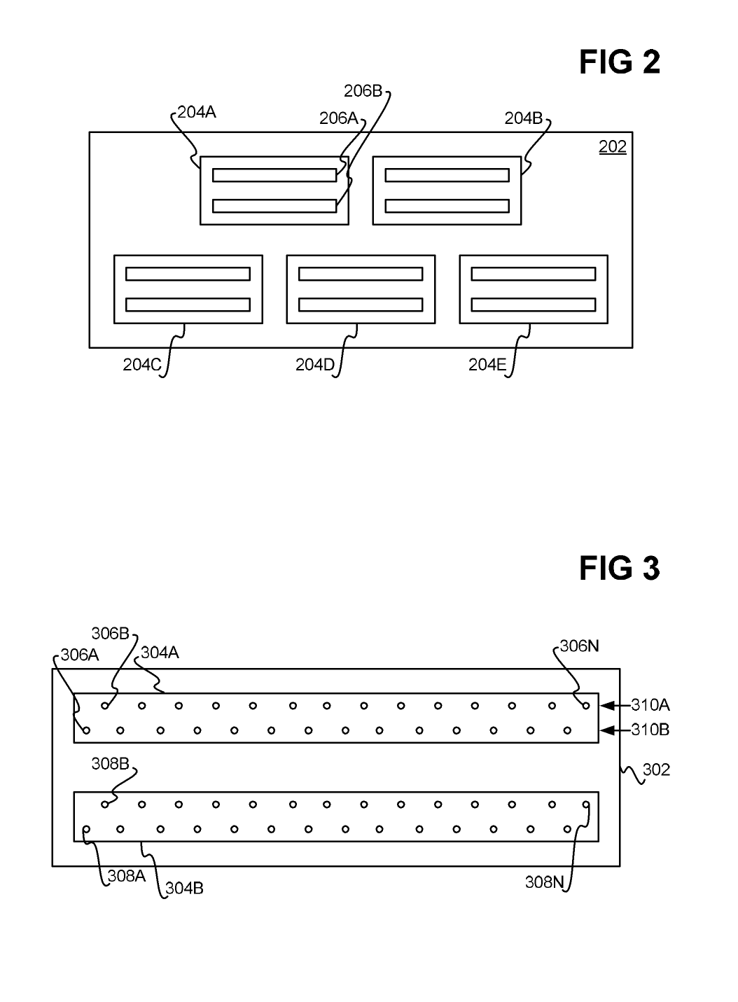

FIG. 2 shows a representative fluid-ejection mechanism 202 in detail, according to an embodiment of the invention. The fluid-ejection mechanism 202 is representative of each of the fluid-ejection mechanisms 106. The fluid-ejection mechanism 202 includes dies, or printheads, 204A, 204B, 204C, 204D, and 204E, collectively referred to as the dies, or printheads, 204. Each of the dies 204 is capable of ejecting fluid therefrom via a number of nozzles organized over two slots. For example, the die 204A includes nozzle slots 206A and 206B, collectively referred to as the slots 206.

FIG. 3 shows a representative die 302 in detail, according to an embodiment of the invention. The die 302 is representative of each of the dies 204. The die 302 includes fluid-ejection nozzles 306A, 306B, . . . , 306N, collectively referred to as the fluid-ejection nozzles 306, within slot 304A, and fluid-ejection nozzles 308A, 308B, . . . , 308N, collectively referred to as the fluid-ejection nozzles 308, within slot 304B. The slots 304A and 304B are collectively referred to as the slots 304.

More specifically, the fluid-ejection nozzles 306 and 308 within the slots 304 are organized within two columns and a larger number of rows within each of the slots 304. For example, the fluid-ejection nozzles 306 within the slot 304A are organized over columns 310A and 310B, collectively referred to as the columns 310, and a larger number of rows, within the slot 304A. In one embodiment, there are 528 fluid-ejection nozzles per each column of each slot, such that there are 1,056 fluid-ejection nozzles per each slot, and thus 2,112 fluid-ejection nozzles per each of the dies, or printheads.

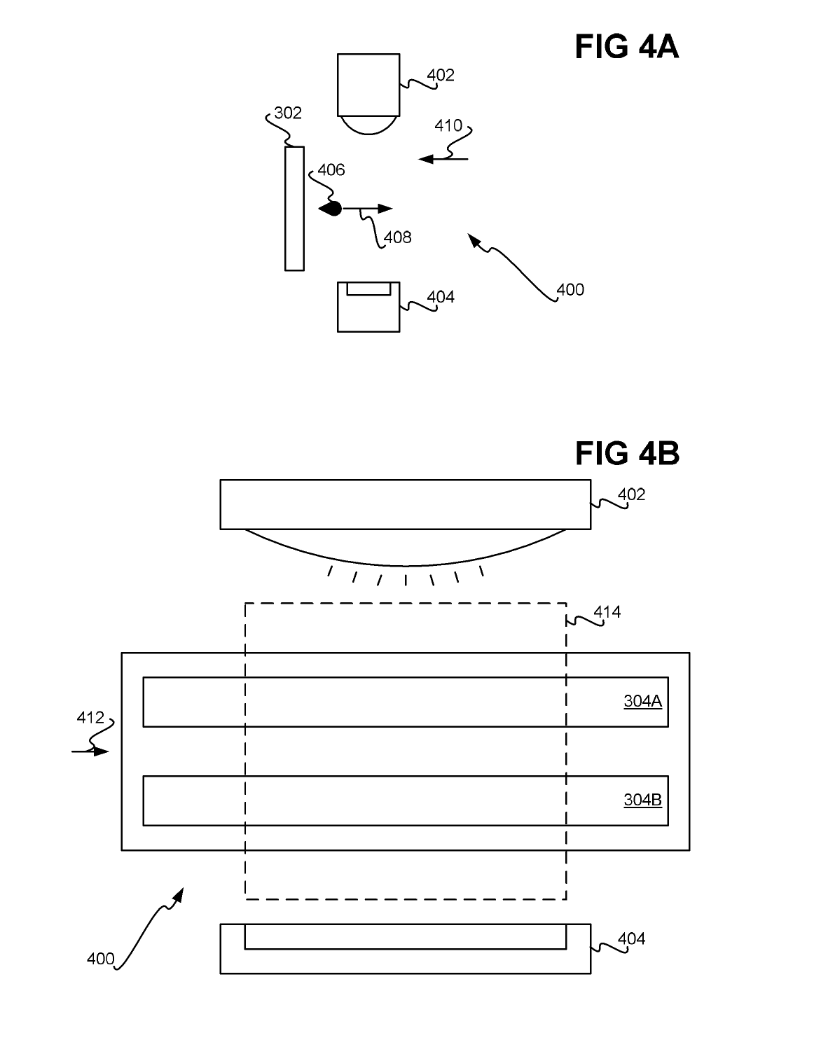

FIGS. 4A and 4B show how a representative drop detector 400 operates, according to an embodiment of the invention. The drop detector 400 is representative of each of the drop detectors 112. The view of FIG. 4A is that which is indicated by the arrow 412 in FIG. 4B, and the view of FIG. 4B is that which is indicated by the arrow 410 in FIG. 4A. Thus, FIG. 4A may be considered a side view and FIG. 4B may be considered a front view of the drop detector 400.

The drop detector 400 is an optical drop detector. An emitter 402, such as a light-emitting diode (LED), emits a beam of light. A detector 404, such as a photodiode, detects the beam of light. As in FIG. 4A, the die 302 ejects fluid from one of its fluid-ejection nozzles 306 and 308, which are not particularly shown in FIGS. 4A and 4B for illustrative clarity and convenience, as a droplet 406, as indicated by the arrow 408. The droplet 406 momentarily breaks the light beam between the emitter 402 and the detector 404. As such, the drop detector 400 detects that the fluid-ejection nozzle of the die 302 that was fired properly ejected fluid.

In FIG. 4B, the detection zone 414 of the drop detector 400 is depicted. The size of the detection zone 414 is exaggerated in FIG. 4B for illustrative clarity. The width of the light beam between the emitter 402 and the detector 404 is less than the width of the slots 304 of the die 302. As a result, just a given number of the fluid-ejection nozzles 306 and 308 are capable of being tested for proper fluid ejection by the drop detector 400 for any given position of the carriage containing the fluid-ejection mechanism of which the die 302 is a part. The number of the fluid-ejection nozzles 306 and 308 that are currently capable of being tested by the drop detector 400, for the current position of this carriage, are those that are positioned within the detection zone 414, and encompass all the columns in which the nozzles 306 and 308 are organized but just some of the rows in which the nozzles 306 and 308 are organized.

In one embodiment, the detection zone 414 encompasses 22 fluid-ejection nozzles per each column of each of the slots 304, such that the detection zone 414 encompasses 44 fluid-ejection nozzles per each of the slots 304, and 88 nozzles of the die 302. A nozzle drop detect index refers to one of a number of positions to which the carriage containing the fluid-ejection mechanism of which the die 302 is a part is moved to or by so that different of the fluid-ejection nozzles can be tested by the drop detector 400 as a result of being positioned within the detection zone 414. In one embodiment, there are 24 nozzle drop detect indices per each column of each of the slots 304. This is because each column of each of the slots 304 includes 528 nozzles, such that where the detection zone 414 encompasses 22 fluid-ejection nozzles per each column, 528 divided by 22 yields 24 nozzle drop detect indices.

Therefore, it is said that the carriage containing the fluid-ejection mechanism of which the die 302 is a part is repeatedly indexed, or advanced, so that each of these 24 drop detect indices can be positioned within the detection zone 414. When a given nozzle drop detect index is positioned within the detection zone 414, the fluid-ejection nozzles 306 and 308 that are part of this nozzle drop detect index are able to be tested by the drop detector 400. As such, the drop detector 400 is calibrated, as is described in detail later in the detailed description, in order for the location of the detection zone relative to a given carriage and to each fluid-ejection mechanism disposed within this carriage is determined, so that the fluid-ejection nozzles of these fluid-ejection mechanisms can be properly tested using the drop detector 400.

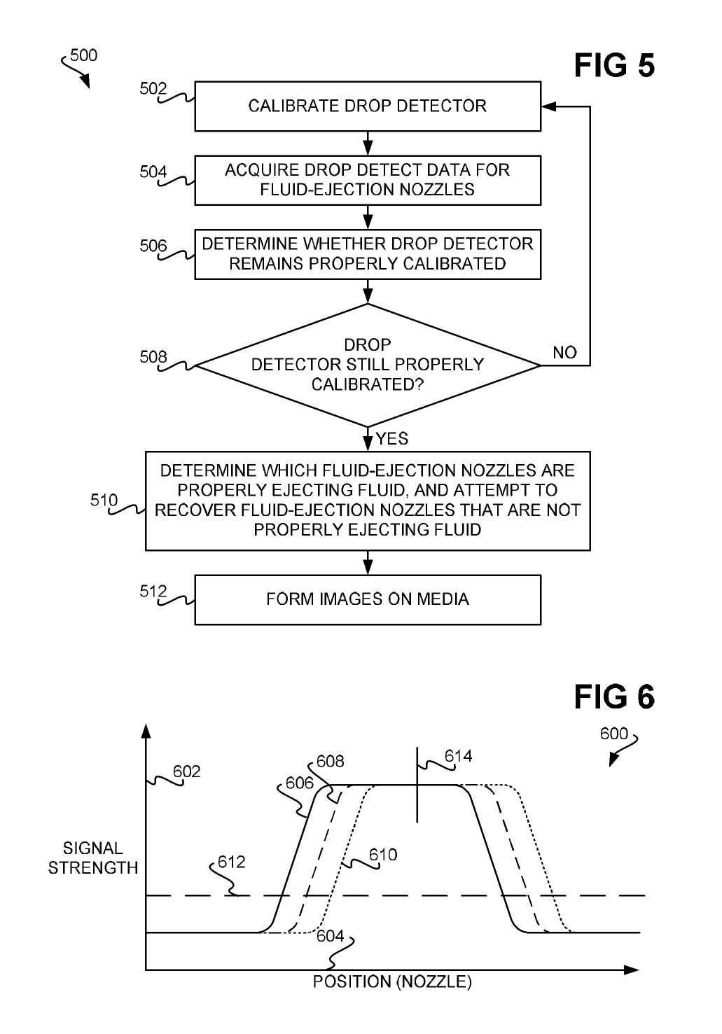

FIG. 5 shows a method 500, according to an embodiment of the invention. The method 500 calibrates a drop detector, and then determines whether the fluid-ejection nozzles of each fluid-ejection mechanism of a carriage are properly ejecting fluid, using the drop detector. The method 500 is performed for each carriage of a fluid-ejection device. Furthermore, some parts of the method 500 may be performed in a different order than is depicted in FIG. 5. For instance, part 506 may be performed while part 504 is being performed, as is described in more detail later in the detailed description.

The method 500 begins by calibrating the drop detector (502). Calibration of the drop detector involves determining a location of the detection zone of the drop detector relative to the carriage. That is, when the carriage is moved to a given location, the location of the detection zone relative to the carriage is determined, so that it can be known which fluid-ejection nozzles of which of the fluid-ejection mechanisms of the carriage will be able to tested using the drop detector at this given location of the carriage. Calibration of the drop detector further involves determining the location of the detection relative to each of the fluid-ejection mechanisms of the carriage. Thus, when the carriage is moved to a given location, the location of the detection zone relative to each fluid-ejection mechanism of the carriage is determined, so that in this way it can also be known which fluid-ejection nozzles of each of the fluid-ejection mechanism will be able to be tested using the drop detector at this given location of the carriage.

FIG. 6 shows a drop detect profile 600 that can be constructed during calibration of the drop detector, according to an embodiment of the invention. The y-axis 602 indicates drop detector signal strength as a function of position on the x-axis 604, where position may be measured by nozzle number. For a given position of the carriage, a number of fluid-ejection nozzles of each of the fluid-ejection mechanisms disposed within the carriage are captured by the drop detect profile 600. This number of fluid-ejection nozzles is said to be encompassed by a drop detector calibration index, which is a different index than the nozzle drop detect index that has been described.

In particular, the drop detector calibration index is larger, encompassing a larger number of fluid-ejection nozzles, than the nozzle drop detect index does. For instance, the drop detector calibration index may encompass 100 fluid-ejection nozzles of each fluid-ejection mechanism of a carriage in one embodiment of the invention, whereas the nozzle drop detect index may encompass just 22 such nozzles, as has been described. The two indices are related, in that fluid-ejection nozzles encompassed by the drop detector index are tested so that the detection zone of the drop detector, measured in size by the nozzle drop detect index, can be determined. Where there are 528 nozzles per column per slot per die of each fluid-ejection mechanism, the carriage may be advanced, or indexed, to one of five different drop detector calibration indices within a given die.

The drop detector profile 600 includes responses 606, 608, and 610 for the three fluid-ejection mechanisms of the carriage in question. Because the fluid-ejection mechanisms of the carriage are spaced out relative to one another, as depicted in FIG. 1, the responses 606, 608, and 610 are offset from one another. For a given drop detector calibration index, 100 nozzles of each of these fluid-ejection mechanisms are fired, and the resulting signals output by the drop detector detecting corresponding fluid ejected by the mechanisms (or not) are recorded to construct the responses 606, 608, and 610, and thus the drop detector profile 600.

Each of the responses 606, 608, and 610 is substantially pulse-like in shape. As to the response 606 as representative of all the responses 606, 608, and 610, the nozzles positioned from one side of the drop detector calibration index to the other are fired in order. Because not all of the fluid ejected by these nozzles is detected, since the drop detector calibration index is larger than the nozzle drop detect index—that is, there are more nozzles encompassed by the former index than can be tested within the detection window—the result is the response 606. Thus, at some point the drop detector begins to detect fluid-ejection nozzles being fired, as indicated by the left edge of the response 606. Likewise, at some point the drop detector can no longer detect fluid-ejection nozzles being fired, as indicated by the right edge of the response 606.

The location of the detection zone relative to the carriage is represented by the width of the pulse represented by the left edge of the leading response 606 through the right edge of the lagging response 610. This width may be measured at an arbitrary threshold 612, or at the maximum signal response, at the horizontal top of the pulses 606, 608, and 610. The center point of this pulse, indicated by the vertical line 614 in FIG. 6, can be considered as the center point of the detection zone relative to the carriage. Where the position on the x-axis 604 measured by nozzles, this location of the detection zone can thus be represented by nozzle number of any of the fluid-ejection mechanisms represented by the responses 606, 608, and 610.

Furthermore, the location of the detection zone relative to each of the fluid-ejection mechanisms can be represented by any of a number of different attributes of the responses 606, 608, and 610. As to the response 606 as representative of all the responses 606, 608, and 610, for instance, the position at which the response 606 crosses the threshold 612 may be used to denote the location of the detection zone relative to the fluid-ejection mechanism that resulted in the response 606. As another example, the center point of the pulse of the response 606 may be used to denote the location of the detection zone relative to this fluid-ejection mechanism.

The location of the detection zone relative to the carriage itself and to each of the fluid-ejection mechanisms of the carriage is used during testing of the fluid-ejection nozzles of the fluid-ejection mechanisms. In particular, by knowing the location of the detection zone, it is known that if the carriage is moved to a given nozzle drop detect index, which fluid-ejection nozzles of which fluid-ejection mechanisms are capable of being tested within the detection zone of the drop detector. If this location is not known, in other words, then a fluid-ejection nozzle may be indicated as not properly ejecting fluid, when in actuality it is, but its fluid ejection is outside of the detection zone and thus not able to be detected by the drop detector.

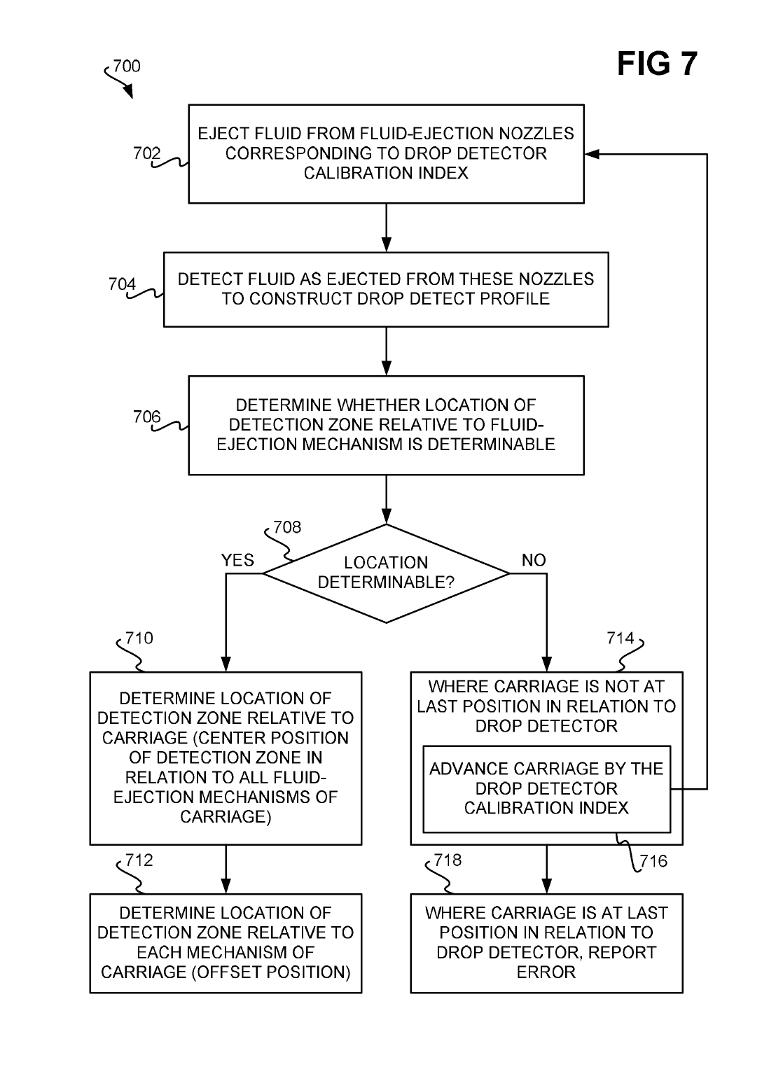

FIG. 7 shows a method 700 for calibrating a drop detector, according to an embodiment of the invention. The method 700 may be performed as part 502 of the method 500. The carriage is moved to an initial position corresponding to the first drop detector calibration index. That is, the carriage is moved to an initial position where it is known a priori that a portion of the fluid-ejection nozzles of the fluid-ejection mechanisms of the carriage will likely include fluid-ejection nozzles that the drop detector is able to detect fluid being ejected therefrom. For instance, where the drop detector calibration index encompasses 100 fluid-ejection nozzles, it may be known that these 100 nozzles are likely to include the 22 nozzles of a nozzle drop detector index that can be tested within the detection zone of the drop detector.

Therefore, fluid is successively ejected from this portion of the fluid-ejection nozzles of each fluid-ejection mechanism corresponding to this drop detector calibration index (702). The fluid ejected from these fluid-ejection nozzles is detected to construct the drop detect profile (704). Next, it is determined whether the location of the detection zone relative to each fluid-ejection mechanism, and thus relative to the carriage itself, is in fact determinable based on the currently constructed drop detect profile (706). For the location of the detection zone to be determined, the drop detect profile has to include responses for the fluid-ejection mechanism that are substantially pulse-like, as has been depicted in and described in relation to FIG. 6.

However, a number of different situations can occur in which there are not substantially pulse-like profiles for all of the fluid-ejection mechanisms of the carriage. First, the drop detector may not be operating properly, or the current drop detector calibration index may not actually encompass fluid-ejection nozzles within the detection zone. As a result, none of the points within the responses of the drop detect profile may be above the threshold 612 of FIG. 6, for instance. Second, for each of one or more of the fluid-ejection mechanisms, there may be more than one low-to-high edge within the corresponding response. In FIG. 6, each of the responses 606, 608, and 610 has just one low-to-high edge, which is the left-most edge of the response. If there is more than one such low-to-high edge, this can indicate that one or more of the fluid-ejection nozzles of the fluid-ejection mechanism are not properly ejecting fluid, such that proper calibration of the drop detector may not be able to be performed.

Third, the width of the response of each of one or more of the fluid-ejection mechanisms may itself be below another threshold, such that, in other words, the pulse of this response is too narrow. Fourth, there may be no leading edge within each of one or more of the responses of the drop detect profile. This means that the current drop detector calibration index is positioned such that the detection zone is not completely within the drop detector calibration index. Similarly, there may be no lagging edge within each of one or more of the responses of the drop detect profile. This also means that the current drop detector calibration index is position such that the detection zone is not completely within the drop detector calibration index, but in the other direction.

Therefore, still referring to FIG. 7, if the location of the detection zone relative to each fluid-ejection mechanism is determinable (708), then the location of the detection zone relative to carriage is in fact determined (710), as is the location of the detection zone relative to each fluid-ejection mechanism (712). The location of the detection zone relative to the carriage may be determined as the center point of the detection zone in relation to the responses within the drop detect profile of all the fluid-ejection mechanisms, as has been described in relation to FIG. 6. The location of the detection zone relative to each fluid-ejection mechanism may then be determined as an offset of the center point, the left edge, or another feature of the response of the fluid-ejection mechanism in relation to this center point.

However, if the location of the detection zone relative to each fluid-ejection mechanism is not determinable (708), then the method 700 performs the following. First, if the carriage is not at its last position in relation to the drop detector (704)—that is, if the carriage is not at the last drop detector calibration index—then the carriage is advanced by a length corresponding to the drop detector calibration index (716), and the method 700 is repeated at part 702. In other words, the carriage is moved so that the fluid-ejection nozzles of the fluid-ejection mechanisms of the carriage that are encompassed by the next drop detector calibration index are used to calibrate the drop detector.

However, if the carriage cannot be moved any further, such that all of the drop detector calibration indices have already been tested, then the method 700 reports an error (718). This means that none of the fluid-ejection nozzles of the fluid-ejection mechanisms within any of the drop detector calibration indices to which the carriage has been moved was able to result in the construction of a proper drop detect profile, such as that of FIG. 6 as has been described. In this situation, the drop detector will not be able to be properly calibrated. That is, the location of the detection zone of the drop detector in relation to the carriage itself and to each fluid-ejection mechanism is not able to be determined.

Referring back to FIG. 5, the method 500 next acquires drop detect data for the fluid-ejection nozzles of all the fluid-ejection mechanisms of the carriage in question (504). In particular, the carriage is indexed in relation to the detection zone of the drop detector, and the fluid-ejection nozzles of the fluid-ejection mechanisms that are capable of being tested within the detect zone are fired in order, with the drop detector indicating whether it correspondingly detect fluid being ejected by the nozzles. The carriage is advanced to the next nozzle drop detect index, and the process is repeated until all of the fluid-ejection nozzles have been tested.

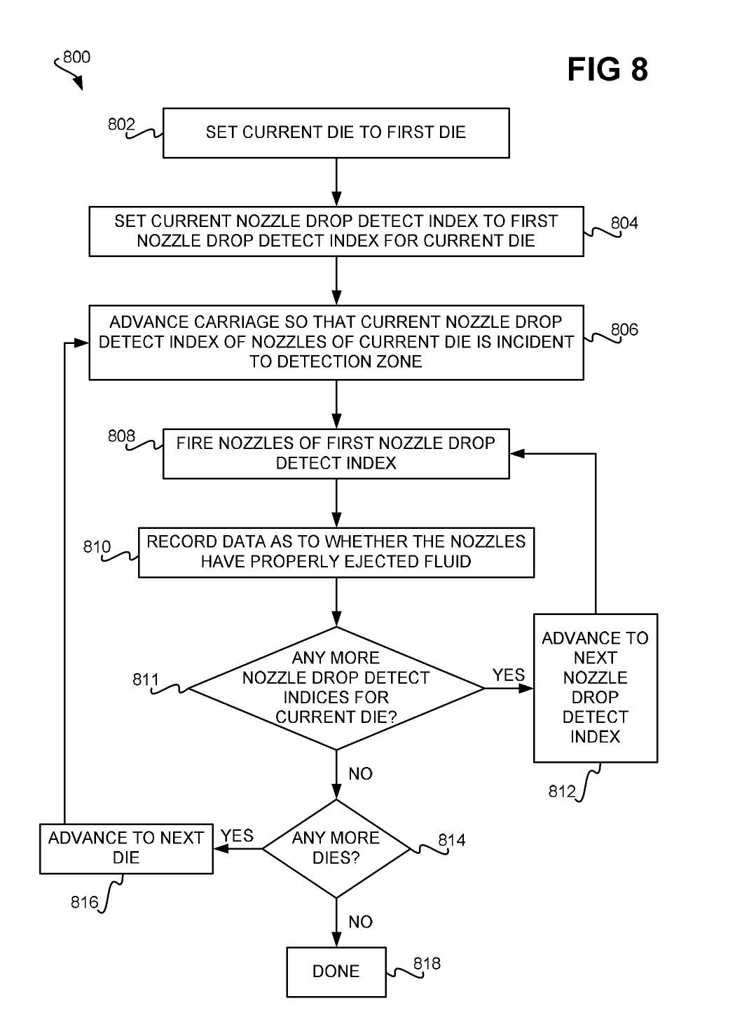

FIG. 8 shows a method 800 for acquiring drop detect data for the fluid-ejection nozzles of all the fluid-ejection mechanisms of a carriage, according to an embodiment of the invention. The method 800 can be performed as part 504 of the method 500. The method 800 is particularly performed for each fluid-ejection mechanism, where each fluid-ejection mechanism includes a number of dies, or printheads, as has been described in relation to FIGS. 2 and 3.

The current die is set to the first die of the fluid-ejection mechanism in question (802). The current nozzle drop detect index is set to the first nozzle drop detect index for the current die (804). The carriage is then advanced so that the current nozzle drop detect index of fluid-ejection nozzles of the current die is incident to the detection zone (806), such that these nozzles are testable by the drop detector. Advancement of the carriage is achieved based on previous calibration of the drop detector—that is, based on the location of the drop detector in relation to the carriage and in relation to the fluid-ejection mechanism in question. Therefore, it can be said that drop detect data is acquired using the location of the drop detector as has been determined during calibration.

Thereafter, the fluid-ejection nozzles of the current nozzle drop detect index of the current die are fired in succession (808). For each of these fluid-ejection nozzles, data is recorded as to whether it has properly ejected fluid (810). Once all of the fluid-ejection nozzles of the current nozzle drop detect index have been so tested, if there are any more nozzle drop detect indices for the current die that contain nozzles that have not yet been tested (811), then the current nozzle drop detect index is advanced to the next such index (812), and the method 800 repeats at 808. Once all the fluid-ejection nozzles of the current die have been tested (811), if there are any more dies of the fluid-ejection mechanism that need to be tested (814), then the current die is advanced to the next die (816), and the method 800 repeats at 816. Ultimately, once all the fluid-ejection nozzles of all the dies have been tested (814), the method 800 is finished (818).

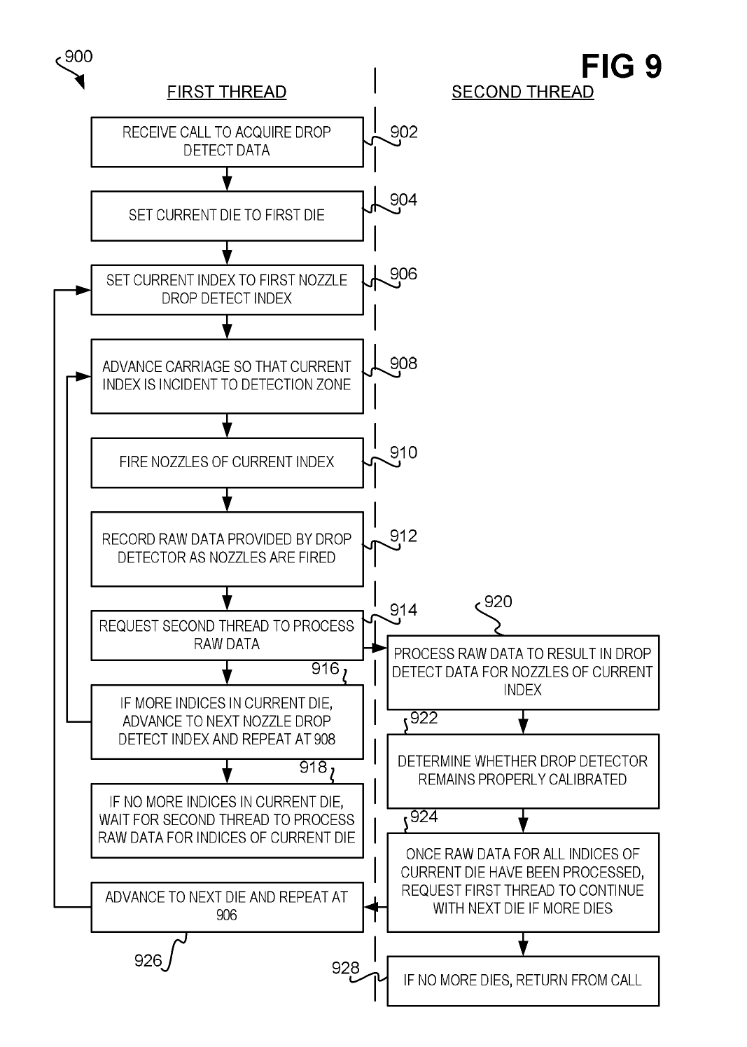

FIG. 9 shows a method 900 for acquiring drop detect data for the fluid-ejection nozzles of all the fluid-ejection mechanisms of a carriage, according to another embodiment of the invention. The method 800 can be performed as part 504 of the method 500. The method 800 is particularly performed for each fluid-ejection mechanism, where each such mechanism includes a number of dies, or printheads, as has been described in relation to FIGS. 2 and 3. The left-hand parts of the method 900 are performed in part by a first thread, or process, of a computer program, while the right-hand parts of the method 900 are performed by a second thread, or process, of the computer program. As such, different parts of the method 900 may be performed concurrently, to accelerate acquisition of drop detect data.

The first thread receives a call to acquire the drop detect data (902). In response, the first thread sets the current die to the first die of the fluid-ejection mechanism in question (904), and sets the current nozzle drop detect index to the first nozzle drop detect index of the current die (906). The carriage is thus advanced so that the current index is incident to the detection zone (908), such that the fluid-ejection nozzles of the current die within the current nozzle drop detect index are capable of being tested by the drop detector. These fluid-ejection nozzles are fired in succession (910), and raw data provided by the drop detector is recorded as they are fired (912).

Once the current nozzle drop detect index of fluid-ejection nozzles have been fired and raw data regarding them recorded, the first thread requests that the second thread process this raw data (914). The first thread advances to the next nozzle drop detect index if there are any nozzle drop detect indices of the current die (916), and repeats at part 908. Otherwise, if all the nozzle drop detect indices of the current die have been tested, then the first thread waits for the second thread to process the raw data for the nozzle drop detect indices of the current die (918). It is noted that the first thread advances to the next index at part 916 and repeats at part 908 while the second thread is processing the raw data that has been recorded in part 912. Therefore, the multiple-threaded method 900 enables drop data acquisition to be performed more quickly than if it were single-threaded, for instance.

When the second thread receives a request to process the raw data for the current nozzle drop detect index of the current die, it processes the raw data to result in the drop detect data for the fluid-ejection nozzles of the current index (920). For example, the raw data may include a value within a range of values that the drop detector can provide as to the breaking of the optical beam by the fluid drops ejected by the fluid-ejection nozzles. The second thread may process this data to result in a binary value for each fluid-ejection nozzle, specifically whether the fluid-ejection nozzle did or did not properly eject fluid. Furthermore, based on the raw data, the second thread may also determine whether the drop detector is still properly calibrated (922). Determining whether the drop detector remains properly calibrated is described later in the detailed description, but the second thread performing this determination in part 922 of the method 900 exemplifies how part 506 of the method 500 can be performed within part 504 of the method 500.

Once the raw data for all the nozzle drop detect indices of the current die have been processed by the second thread, the second thread requests the first thread to continue with the next die if there are any other dies within the fluid-ejection mechanism in question that have not yet been tested (924). Thus, the first thread receives this request, advances the current die to the next die (926), and repeats at part 906. Once all the fluid-ejection nozzles of all the dies have been tested, and their raw data processed, the second thread returns from the call that was originally received by the first thread (928).

Referring back to FIG. 5, the method 500 determines whether the drop detector has remained properly calibrated (506). If not (508), then the method 500 repeats at part 502, so that the drop detector can be calibrated again. The drop detector can become miscalibrated even after it already has been properly calibrated for a variety of different reasons. For example, the carriage may include an encoder strip that can expand and contract, causing positioning errors of the drop detector in relation to the carriage.

In general, determining whether the drop detector is still properly calibrated can include determining whether the drop detect data that has been acquired reflects that periodically occurring fluid-ejection nozzles of one or more of the fluid-ejection mechanisms on the carriage are no longer ejecting fluid onto the drop detector when being fired. As has been described, acquisition of the drop detect data can involve indexing the carriage in relation to each die of each fluid-ejection mechanism. If for a given fluid-ejection mechanism, an increasing number of fluid-ejection nozzles at the edges of each nozzle drop detect index of the dies are not being detected by the drop detector when they are fired, in great likelihood this means that the drop detector is no longer properly calibrated.

This situation occurs when these fluid-ejection nozzles at the edges of the nozzle drop detect indices of the dies are no longer within the detection zone when firing. By comparison, the likelihood that these nozzles at the edges of the nozzle drop detect indices of the dies have suddenly stopped working is relatively low. In other words, the likelihood that periodically occurring of the fluid-ejection nozzles over the dies are no longer working is low, such periodicity rather pointing to these nozzles not being within the detection window of the drop detector.

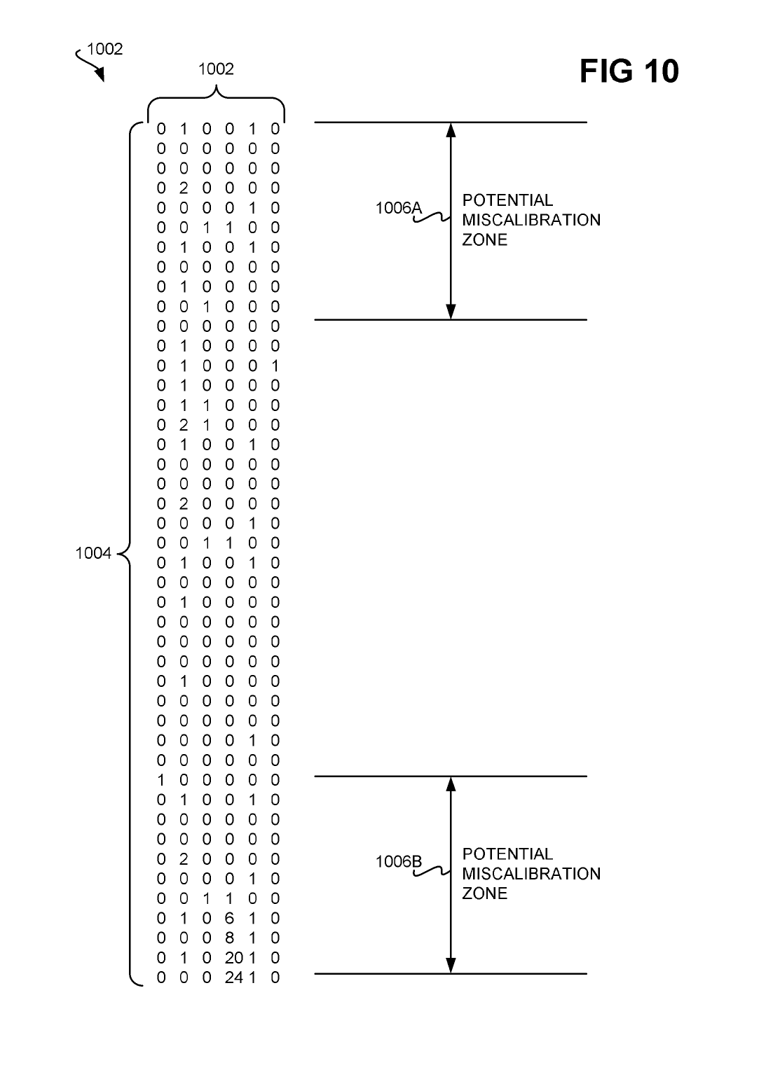

FIG. 10 shows a histogram 1000 that can be constructed from the drop detect data to determine whether the drop detector is still properly calibrated, according to an embodiment of the invention. The histogram 1000 includes six column 1002, corresponding to six fluid-ejection mechanisms, such as the six fluid-ejection mechanisms 106. The histogram 1000 includes 44 rows 1004. There are 44 rows 1004 because a nozzle drop detect index encompasses 44 fluid-ejection nozzles within a given slot of a given die. That is, the 44 rows 1004 correspond to fluid-ejection nozzle position within each nozzle drop detect index.

The values within the histogram 1000 indicate the number of fluid-ejection nozzles having the corresponding fluid-ejection nozzle position within the nozzle drop detect index that the drop detector did not detect ejection of fluid therefrom. Each fluid-ejection mechanism can include five dies, with two slots per die, and 24 nozzle drop detect indices per slot, as has been described. This means that there are 5×2×24, or 240 nozzle drop detect indices over the fluid-ejection mechanism itself, such that each value within the histogram 1000 can be no greater than 240, which is the number of fluid-ejection nozzles at a given position within any nozzle drop detect index for the fluid-ejection mechanism in question.

For example, the value for the last row and the fourth column is 24. The last row corresponds to the 44^{th} fluid-ejection nozzle of each nozzle drop detect index. The fourth column itself refers to the fourth fluid-ejection mechanism. Therefore, of the 44^{th} fluid-ejection nozzle of each nozzle drop detect index within the fourth fluid-ejection mechanism, there are 240 such nozzles for the fourth fluid-ejection mechanism, and 24 of these nozzles were not detected by the drop detector as properly ejecting fluid.

In one embodiment, two potential miscalibration zones 1006A and 1006B, collectively referred to as the potential miscalibration zones 1006, are of particular interest within the histogram 1000. The miscalibration zone 1006A includes the first ten fluid-ejection nozzles of each nozzle drop detect index for a given fluid-ejection mechanism, while the miscalibration zone 1006B includes the last ten fluid-ejection nozzles of each nozzle drop detect index for a given fluid-ejection mechanism. Rapidly decreasing values within any column over the miscalibration zone 1006A, or rapidly increasing values within any column over the miscalibration zone 1006B, indicates that in all likelihood the drop detector is no longer properly calibrated as to the fluid-ejection mechanism corresponding to this column. The former situation can denote that the detection window has shifted so that the leading fluid-ejection nozzles within the drop detect indices are no longer within the detection window, and the latter situation can denote that the detection window has shifted so that the lagging nozzles within the drop detect indices are no longer within the detection window.

For example, decreasing values within any column of the histogram 1000 over the potential miscalibration zone 1006A are indicative of fluid-ejection nozzles at the leading positions of nozzle drop detect indices for a fluid-ejection mechanism not being detected by the drop detector. Because of the periodicity of these fluid-ejection nozzles, in all likelihood the fluid-ejection nozzles at the leading positions of nozzle drop detect indices are no longer within the detection window. As another example, increasing values within any column of the histogram 1000 over the potential miscalibration zone 1006B are indicative of fluid-ejection nozzles at the lagging positions of nozzle drop detect indices for a fluid-ejection mechanism not being detected by the drop detector. Here, too, because of the periodicity of these fluid-ejection nozzles, in all likelihood the fluid-ejection nozzles at the lagging positions of nozzle drop detect indices are no longer within the detection window.

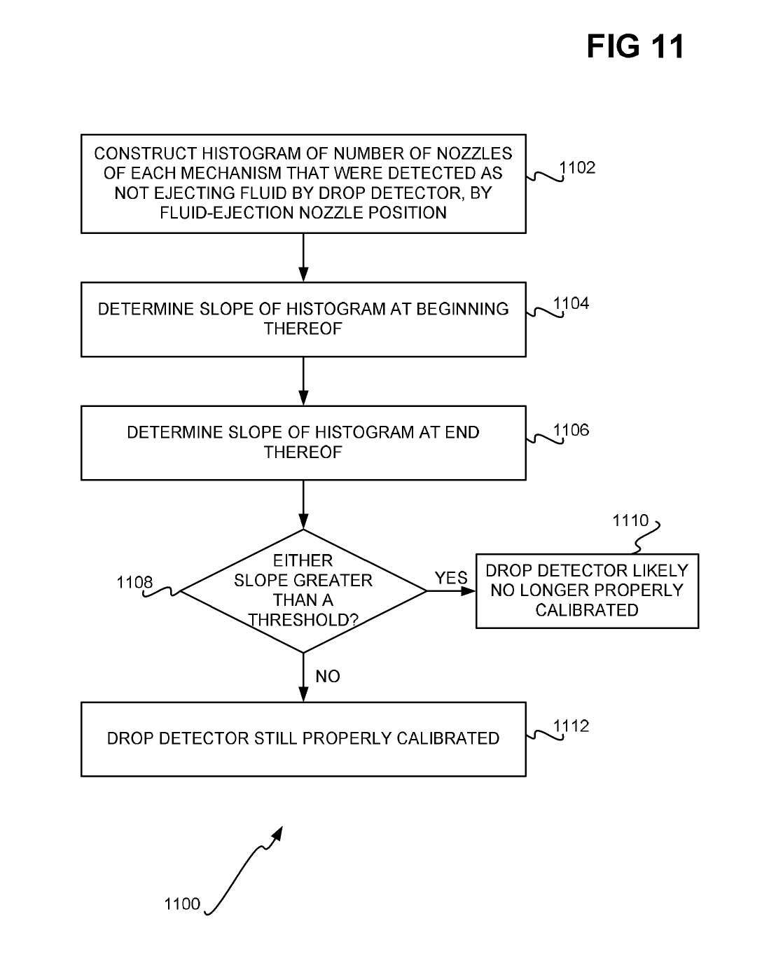

FIG. 11 shows a method 1100 for determining whether the drop detector is still properly calibrated, according to an embodiment of the invention. The method 1100 may be performed as part 506 of the method 500. The histogram 1000 is first constructed (1102). The histogram indicates the number of fluid-ejection nozzles of each fluid-ejection mechanism that were detected by the drop detector as not ejecting fluid, by fluid-ejection nozzle position within a nozzle drop detect index. As has been described in relation to FIG. 10, the columns of the histogram correspond to the fluid-ejection mechanisms, and the rows correspond to fluid-ejection nozzle position within the nozzle drop detect indices.

The slope of the histogram at its beginning is determined for each column (1104), as is the slope of the histogram at its end for each column (1106). For example, in relation to the histogram 1000, the slope of the histogram 1000 at its beginning for each column is the rate of decrease of the values within the potential miscalibration zone 1006A for each of the columns 1002. Each such slope is the rate of decrease of the number of nozzles of a fluid-ejection mechanism that did not eject fluid onto the drop detector when being fired, at the beginning of the nozzle drop detect indices. Likewise, the slope of the histogram 1000 at its end for each column is the rate of increase of the values within the potential miscalibration zone 1006B for each of the columns 1002. Each such slope is the rate of increase of the number of nozzles of a fluid-ejection mechanism that did not eject fluid onto the drop detector when being fired, at the end of the nozzle drop detect indices.

A relatively steep slope at either the potential miscalibration zone 1006A or the potential miscalibration zone 1006B is indicative that the drop detector is no longer properly calibrated in relation to the fluid-ejection mechanism in question. Therefore, where either such slope is greater than a threshold (1108), it is concluded that the drop detector is likely no longer properly calibrated (1110). Otherwise, it is concluded that the drop detector is still properly calibrated (1112). The slope determination in parts 1104 and 1106 of the method 1100 can be performed in any of a number of different ways. For example, the maximum slope between any two adjacent rows within a given column may be considered the slope in question, or the average slope of each pair of adjacent rows within a given column may be considered the slope in question.

Referring back to FIG. 5, if the drop detector is still properly calibrated (508), then the method 500 determines which fluid-ejection nozzles of the fluid-ejection mechanism are properly ejecting fluid, and attempts to recover those nozzles that are not properly ejecting fluid (510). In one embodiment, recovery is attempted for fluid-ejection nozzles that are not properly ejecting fluid where it is determined that image formation quality that results from fluid ejection by the nozzles of the fluid-ejection mechanisms will be sub par. This determination can be made in a number of different ways. As one relatively straightforward approach, if the number of fluid-ejection nozzles that are not properly ejecting fluid is greater than a threshold, then recovery of these nozzles is attempted.

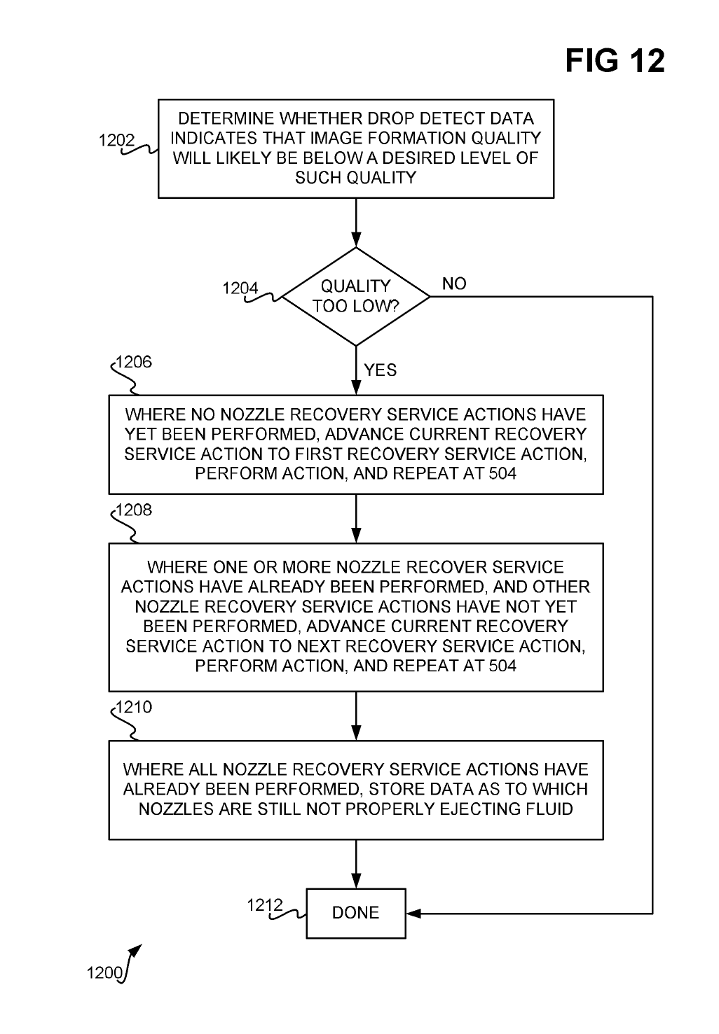

FIG. 12 shows a method 1200 that can be performed to determine which fluid-ejection nozzles of the fluid-ejection mechanism are properly ejecting fluid, and attempting to recover those nozzles that are not properly ejecting fluid, according to an embodiment of the invention. The method 1200 may be performed as part 510 of the method 500. In general, determining which fluid-ejection nozzles of the fluid-ejection mechanism are properly ejecting fluid is achieved by examining the drop detect data that has been acquired. The drop detect data itself can specify which nozzles are properly ejecting fluid and which are not. For example, for each fluid-ejection nozzle of the fluid-ejection mechanism, the drop detect data may provide a binary value, where one such value indicates a properly functioning nozzle, and another such value indicates an improperly functioning nozzle.

The method 1200 thus determines whether the drop detect data indicates that image formation quality that will result from using the fluid-ejection nozzles of the fluid-ejection mechanism to form images on media will likely be below a desired level of image formation quality (1202). As has been noted, this determination can be made in a number of different ways. For example, if the number of nozzles that are not properly ejecting fluid is greater than a threshold, then it may be concluded that image formation quality will be below a desired level of image formation quality. More sophisticated approaches to determine whether image formation quality will likely be below a desired level of quality can also be employed. The improperly functioning fluid-ejection nozzles may be weighted based on their position, for instance, and so on.

If it is determined that image formation quality that will result will likely be below the desired level of quality (1204), then the following is performed. First, if no nozzle recovery service actions have been performed yet (1206), a current recovery service action is advanced to the first such action, this action is performed, and the method 1200 repeats at part 504 of the method 500. For example, there may be three different nozzle recovery service actions that can be performed. The first action may be the most severe, in terms of amount of fluid ejected and/or the amount of time that it takes to service the nozzles, or it may be the least severe. The second and third actions may increase or decrease in their severity.

In general, a nozzle recovery service action is an action that is performed to attempt to recover the fluid-ejection nozzles that are not properly ejecting fluid, so that the fluid-ejection nozzles subsequently do properly ejecting fluid. A nozzle recovery service action may involve, for instance, one or more spits, in which fluid is attempted to be forcibly ejected from the nozzles to clear the nozzles from any clogs. A nozzle recovery service action may also involve, for instance, one or more wipes, in which the fluid-ejection nozzles are wiped against a wiping material in an attempt to clean the nozzles so that they subsequently properly eject fluid. Different types of nozzle recovery service actions may be performed.

If one or more nozzle recovery service actions have already been performed, but other nozzle recovery service actions have not yet been performed (1208), then the current recovery service action is advanced to the next such action, this action is performed, and the method 1200 again repeats at part 504 of the method 500. In the example where there are three different nozzle recovery service actions, the first such action may have been performed, but the second and third actions may not yet have been performed. Therefore, the current recovery service action is advanced from the first to the second such action, and the second action is performed. If the first and the second actions have already been performed, then the current recovery service action is advanced from the second to the third action, and the third action is performed.

If all the nozzle recovery service actions have been performed, and image formation quality is still likely to be below a desired level of quality (1210), then the method 1200 stores data as to which fluid-ejection nozzles are still not properly ejecting fluid, even after the performance of a number of nozzle recovery service actions. This data can then be used to perform various error-hiding approaches to compensate for the non-functioning nozzles. For example, one fluid-ejection nozzle may take over fluid ejection for another fluid-ejection nozzle. As another example, dithering or another approach may be employed to attempt to hide the fact that a given fluid-ejection nozzle is not able to eject fluid to form images on media.

Finally, where it is determined that the image formation quality is likely to be below a desired level of quality (1204), or where all the nozzle recovery service actions that can be performed have been performed (1210), the method 1200 is finished (1212). Referring back to FIG. 5, the fluid-ejection mechanism can then be used to form images on media (512). Thus, the method 500, as has been described in relation to FIGS. 6-12, is used to calibrate a drop detector, and then using the drop detector to acquire drop detect data for fluid-ejection nozzles, so that it can be determined which nozzles are properly ejecting fluid and which are improperly ejecting fluid. Based on this knowledge, various recovery actions may be undertaken. Furthermore, the method 500 determines whether the drop detector has become miscalibrated even after it has been calibrated. As such, the method 500 provides for substantially the optimal level of image formation quality when ultimately forming images on media using the fluid-ejection mechanisms, based on the fluid-ejection nozzles that are properly ejecting fluid.

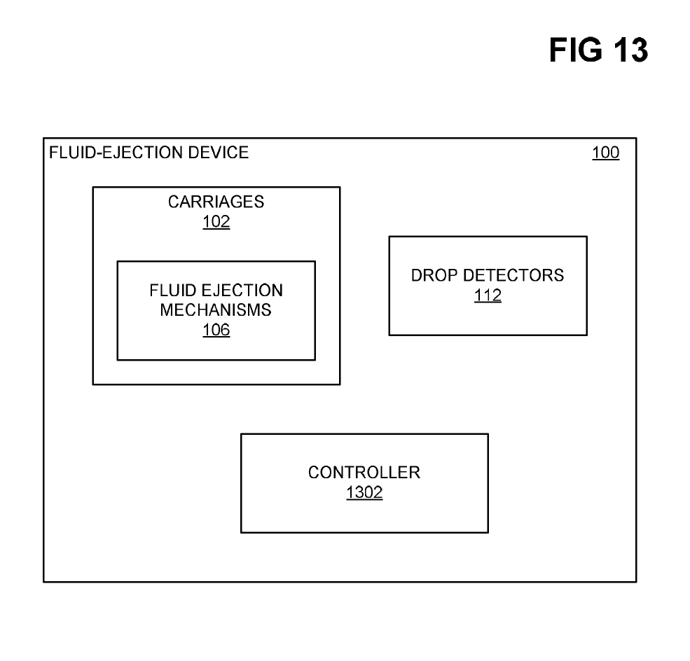

In conclusion, FIG. 13 shows a rudimentary block diagram of the fluid-ejection device 100, according to an embodiment of the invention. The fluid-ejection device 100 includes the carriages 102 on which the fluid-ejection mechanisms 106 are disposed, one or more drop detectors 112, and a controller 1302. As can be appreciated by those of ordinary skill within the art, the fluid-ejection device 100 can include other components, in addition to and/or in lieu of those depicted in FIG. 13.

The carriages 102 remain stationary while images are formed on media, as has been described. The fluid-ejection mechanisms 106 each have a number of fluid-ejection nozzles from which fluid is ejected to form the images on media. The fluid in question can be ink, fixer, or another type of fluid. As such, the fluid-ejection device 100 may be an inkjet-printing device, such as an inkjet printer, such that the fluid-ejection mechanisms 106 are inkjet mechanisms.

The drop detectors 112 each have a detection zone within which the drop detector is able to detect whether a portion of the fluid-ejection nozzles of one or more of the mechanisms 106 are properly ejecting fluid. This portion of the fluid-ejection nozzles is encompassed by a nozzle drop detect index, as has been described. The drop detectors 112 can be optical drop detectors, or another type of drop detector, such as electrostatic drop detectors, for instance.

The controller 1302 may be implemented in hardware, software, or a combination of hardware and software. The controller 1302 may be or include the firmware for the fluid-ejection device 100. In general, the controller 1302 performs the method 500 that has been described, as well as the other methods that have been described. For instance, the controller 1302 calibrates the drop detectors 112, and recalibrates the drop detectors 112 as needed. The controller 1302 acquires drop detect data for the fluid-ejection nozzles, uses the drop detect data to determine whether nozzle service recovery actions should be performed, and causes these actions to be performed.

We claim:

1. A method comprising:
calibrating a drop detector to determine a location of a detection zone thereof relative to a carriage and to each of one or more fluid-ejection mechanisms disposed within the carriage;
acquiring drop detect data for a plurality of nozzles of each mechanism by indexing the carriage in relation to the detection zone and attempting to eject fluid from the nozzles, based on the location of the detection zone relative to the carriage and to each mechanism;
determining whether the drop detector remains properly calibrated, based on the drop detect data, and repeating the method at calibrating the drop detector where the drop detector is no longer properly calibrated; and,
determining which of the nozzles are properly ejecting fluid therefrom, based on the drop detect data, and attempting to recover the nozzles that are improperly ejecting fluid therefrom.

2. The method of claim 1, wherein calibrating the drop detector comprises:
ejecting fluid from a portion of the nozzles of each mechanism corresponding to a drop detector calibration index;
detecting the fluid as ejected from the portion of the nozzles of each mechanism via the drop detector to construct a drop detect profile;
determining whether the location of the detection zone relative to each mechanism is determinable, based on the drop detect profile;
in response to determining that the location of the detection zone relative to each mechanism is determinable;
determining the location of the detection zone relative to the carriage by determining a center position of the detection zone in relation to all the mechanisms; and,
determining the location of the detection zone relative to each mechanism by calculating an offset of a position of a start of the detection zone for the mechanism in relation to the center position of the detection zone.

3. The method of claim 2, wherein determining that the location of the detection zone relative to each mechanism is determinable comprises determining that the drop detect profile includes a pulse-like profile for each mechanism.

4. The method of claim 2, where calibrating the drop detector further comprises:
in response to determining that the location of the detection zone relative to each mechanism is not determinable,
where the carriage is not at a last position in relation to the drop detector;
advancing the carriage in relation to the drop detector by the drop detector calibration index;
repeating the method at ejecting the fluid from the portion of the carriage of each mechanism corresponding to the drop detector calibration index; and,
where the carriage is at the last position in relation to the drop detector, reporting an error.

5. The method of claim 4, wherein determining that the location of the detection zone relative to each mechanism is not determinable comprises determining that one or more of a number of conditions have occurred, for each of one or more of the mechanisms, the number of conditions comprising:
all of a plurality of points within the pulse-like profile for the mechanism are below a first threshold;
a plurality of low-to-high edges within the pulse-like profile for the mechanism exist;
a width of the pulse-like profile for the mechanism is below a second threshold;
the pulse-like profile for the mechanism has no leading edge; and,
the pulse-like profile for the mechanism has no trailing edge.

6. The method of claim 1, wherein acquiring the drop detect data for the plurality of nozzles of each mechanism comprises, where the nozzles of the mechanism are distributed over a plurality of dies:
setting a current die to a first die of the plurality of dies;
setting a current nozzle drop detect index of nozzles of the current die to a first nozzle drop detect index of nozzles of the current die;
repeating
advancing the carriage in relation to the drop detector so that the current nozzle drop detect index of the nozzles of the current die is incident to the detection zone;
firing the nozzles of the current nozzle drop detect index of the current die; and,
recording data as to whether each of the nozzles of the current nozzle drop detect index has properly ejected fluid,
advancing the current nozzle drop detect index of nozzles of the current die to a next nozzle drop index of nozzles of the current die unless the current nozzle drop detect index of nozzles of the current die is a last nozzle drop detect index of nozzles of the current die;
until all the nozzles of the current die have been fired,
advancing the current die to a next die unless the current die is a last die;
until all the nozzles of all the dies have been fired.

7. The method of 1, wherein acquiring the drop detect data for the plurality of nozzles of each mechanism comprises, for each mechanism:
a) a first thread receiving a call to acquire the drop detect data;
b) the first thread setting a current die to a first die of a plurality of dies of the mechanism over which the nozzles of the mechanism are distributed;
c) the first thread setting a current index to a first nozzle drop detect index of the nozzles of the current die;
d) the first thread advancing the carriage in relation to the drop detector so that the current nozzle drop detect index of the nozzles of the current die is incident to the detection zone;
e) the first thread firing the nozzles of the current nozzle drop detect index of the current die;
f) the first thread recording raw data provided by the drop detector as the nozzles of the current nozzle drop detect index are fired;
g) the first thread requesting a second thread to process the raw data;
h) the second thread processing the raw data to result in the drop detect data for the nozzles of the current nozzle drop detect index of the current die;
i) where the current index is not equal to a last nozzle drop detect index of the nozzles of the current die, the first thread advancing the current index to a next nozzle drop detect index of the nozzles of the current die and repeating at d);
j) where the current die is not equal to a last die of the plurality of dies, the second thread requesting that the first thread continue with a next die once the second thread has finished processing the raw data for the current die, such that the first thread advances the current die to a next die and repeats at c); and,
k) where the current die is equal to the last die, the second thread returning from the call to acquire the drop detect data once the second thread has finished processing the raw data for the current die.

8. The method of claim 7, wherein acquiring the drop detect data for the plurality of nozzles of each mechanism further comprises the second thread determining whether the drop detector remains properly calibrated at h), and repeats the method at calibrating the drop detector where the drop detector is no longer properly calibrated.

9. The method of claim 1, wherein determining whether the drop detector remains properly calibrated comprises determining that the drop detect data reflects that periodically occurring of the nozzles do not eject fluid onto the drop detector when being fired.

10. The method of claim 1, wherein determining whether the drop detector remains properly calibrated comprises, for each mechanism:
constructing a histogram of a number of the nozzles of the mechanism that did not eject fluid onto the drop detector when being fired;
determining a first slope of the histogram at a beginning of the histogram, corresponding to the rate of decrease of the number of the nozzles of the mechanism that did not eject fluid onto the drop detector when being fired at a beginning of a nozzle drop detect index;
determining a second slope of the histogram at an end of the histogram, corresponding to the rate of increase of the number of nozzles of the mechanism that did not eject fluid onto the drop detector when being fired at an end of a nozzle drop detect index; and,
where the first slope or the second slope is greater than a threshold, concluding that the drop detector is no longer properly calibrated.

11. The method of claim 1, wherein determining which of the nozzles are properly ejecting fluid and attempting to recover the nozzles that are improperly ejecting fluid comprises:
determining whether the drop detect data indicates that image formation quality resulting from fluid ejection by the nozzles is likely to be below a desired level of image formation quality; and,
in response to determining that the drop detect data indicates that the image formation quality is likely to be below the desired level of image formation quality:
performing one or more nozzle recovery service actions to recover the nozzles that are improperly ejecting fluid therefrom, and repeating the method at acquiring the drop detect data.

12. The method of claim 1, wherein determining which of the nozzles are properly ejecting fluid and attempting to recover the nozzles that are improperly ejecting fluid comprises:
determining whether the drop detect data indicates that image formation quality resulting from fluid ejection by the nozzles is likely to be below a desired level of image formation quality;
in response to determining that the drop detect data indicates that the image formation quality is likely to be below the desired level of image formation quality:
where no nozzle recovery service actions have yet been performed
advancing a current recovery service action to a first recovery service action;
performing the current recovery service action and repeating the method at acquiring the drop detect data;
where one or more nozzle recovery service actions have been performed and one or more other nozzle recovery service actions have not yet been performed;
advancing the current recovery service action to a next recovery service action; and,
performing the current recovery service action and repeating the method at acquiring the drop detect data.

13. The method of claim 12, wherein determining which of the nozzles are properly ejecting fluid and attempting to recover the nozzles that are improperly ejecting fluid further comprises:
where all of the nozzle recovery service actions have been performed, storing data as to which of the nozzles are still improperly ejecting fluid therefrom so that error hiding can be performed as to the nozzles that are still improperly ejecting fluid therefrom during image formation.

14. The method of claim 1, further comprising forming images on media by ejecting fluid from the nozzles of the fluid-ejection mechanisms as the media is advanced past the carriage and while the carriage remains stationary.

15. The method of claim 1, wherein the nozzles of each mechanism are organized along a number of columns and a number of rows, the number of rows greater than the number of columns, the detection zone having a size encompassing all the columns but just some of the rows, such that the not all of the nozzles of the mechanism are capable of simultaneously ejecting fluid within the detection zone.

16. The method of claim 1, wherein the fluid-ejection mechanisms are inkjet mechanisms, such that the fluid ejected from the nozzles thereof is ink.

17. A fluid-ejection device comprising:
one or more carriages, each carriage having one or more fluid-ejection mechanisms disposed therein, each fluid-ejection mechanism having a plurality of nozzles from which fluid is ejectable, the carriages remaining stationary while the nozzles eject fluid onto media;
one or more drop detectors, each drop detector having a detection zone within which the drop detector is to detect whether a portion of the nozzles are properly ejecting fluid; and,
a controller to calibrate the drop detectors to determine the location of the detection zone, to acquire drop detect data for the nozzles of each mechanism, and to recalibrate the drop detectors upon determining that the drop detectors are no longer properly calibrated.

18. The fluid-ejection device of claim 17, wherein the nozzles of each mechanism are organized along a number of columns and a number of rows, the number of rows greater than the number of columns, the detection zone having a size encompassing all the columns but just some of the rows, such that the not all of the nozzles of the mechanism are capable of simultaneously ejecting fluid within the detection zone.

19. The fluid-ejection device of claim 17, wherein the fluid-ejection mechanisms are inkjet mechanisms, such that the fluid ejected from the nozzles thereof is ink, and the fluid-ejection device is an inkjet-printing device.

20. A fluid-ejection device comprising:
one or more carriages, each carriage having one or more fluid-ejection mechanism disposed therein, each fluid-ejection mechanism having a plurality of nozzles from which fluid is ejectable, the carriages remaining stationary while the nozzles eject fluid onto media;
one or more drop detectors, each drop detector having a detection zone within which the drop detector is to detect whether a portion of the nozzles are properly ejecting fluid; and,
means for calibrating the drop detectors to determine the location of the detection zone, for acquiring drop detect data for the nozzles of each mechanism, and for recalibrating the drop detectors upon determining that the drop detectors are no longer properly calibrated.
